(19) United States
(12) Patent Application Publication
(10) Pub. No.: US 2023/0327407 A1
(43) Pub. Date: Oct. 12, 2023

(54) IGNITION DEVICE

(71) Applicant: Mitsubishi Electric Corporation, Tokyo (JP)

(72) Inventor: Kimihiko TANAYA, Tokyo (JP)

(73) Assignee: Mitsubishi Electric Corporation, Tokyo (JP)

(21) Appl. No.: 18/156,488

(22) Filed: Jan. 19, 2023

(30) Foreign Application Priority Data
Mar. 16, 2022 (JP) 2022-040943

(51) Int. Cl. F02P 9/00; H01T 13/20; H01T 13/52

(52) U.S. Cl. CPC H01T 13/20; F02P 9/002; H01T 13/52

(57) ABSTRACT

An object herein is to provide, with respect to a spark ignition-type internal combustion engine in which the pressure of the air-fuel mixture in the combustion chamber becomes high, an ignition device which can suppress occurrence of a creeping discharge and thus contributes to highly efficient operation of the internal combustion engine. The ignition device according to this application includes: an ignition plug having a high-voltage side electrode and a ground side electrode; a high voltage generation device that applies a voltage to the high-voltage side electrode of the ignition plug; and an extension device that extends a dielectric breakdown-reaching time period that is a time period from when the voltage is applied to the high-voltage side electrode of the ignition plug, to when a voltage between the high-voltage side electrode and the ground side electrode of the ignition plug reaches a dielectric breakdown voltage.

### TECHNICAL FIELD

The present application relates to an ignition device.

### BACKGROUND

Efforts have been initiated worldwide to achieve greenhouse gas reduction as a countermeasure against global warming as an issue raised recently. In the automobile industry, such a countermeasure is of course required, so that developments for improving the efficiency of the internal combustion engine are underway.

In these developments, there is included a development about a down-sized internal combustion engine which can achieve power equivalent to that of a conventional internal combustion engine, even though it is smaller and lighter than the conventional internal combustion engine. In this respect, such a method is employed in which a small-displacement internal combustion engine is operated while being supercharged, to thereby increase the efficiency of that engine. Further, in order to take out energy due to thermal expansion more efficiently, it is promoted to install a high compression-rate internal combustion engine. In these internal combustion engines, a pressure in the combustion chamber is set to be higher than that of the conventional internal combustion engine.

In an internal combustion engine of a spark ignition type, an ignition device applies a high voltage to an ignition plug provided in the combustion chamber. Dielectric breakdown occurs due to the high voltage applied between the center electrode and the lateral side electrode of the ignition plug. A gap between the electrodes with the presence of an air-fuel mixture is referred to as an air gap. The ignition device causes dielectric breakdown in the air gap to generate a spark discharge, to thereby ignite the air-fuel mixture in the combustion chamber. The ignited air-fuel mixture is combusted, so that the internal combustion engine operates.

Meanwhile, the higher the pressure of a gas becomes, the less likely is dielectric breakdown to occur in the gas. If dielectric breakdown becomes difficult to occur in the air gap, a creeping discharge will be induced. The creeping discharge is a phenomenon of electric breakdown that occurs in a gap (creepage gap) along a surface of an insulator and between a metal portion of the ignition device having a potential same as that of the lateral side electrode (ground side electrode), and the center electrode (high-voltage side electrode) to which the high voltage is applied.

The combustion flame ignited by the creepage discharge as a discharge along the insulator, emerges along the insulator, so that the combustion heat will be taken by the insulator through heat conduction, resulting in decreased quantity of heat. This reduces the combustibility of the air-fuel mixture in the combustion chamber. In addition, the discharge under a high pressure generates a very high temperature to thereby melt and abrade the surface of the insulator where the discharge occurs. This shortens the life of the ignition plug.

Accordingly, for internal combustion engines in which the pressure of the air-fuel mixture in the combustion chamber becomes high, it is required to suppress occurrence of the creeping discharge. As a means for avoiding the creeping discharge, there is proposed an ignition plug in which the high-voltage side electrode and the ground side electrode are formed into unusual shapes (for example, Patent Document 1).

### CITATION LIST

### Patent Literature

Patent Document 1: Japanese Patent Application Laid-open No.2018-174132

In recent years, for automotive internal combustion engines, it is required to set the pressure of the air-fuel mixture in the combustion chamber higher than before. Thus, according to a conventional ignition plug, it is becoming difficult to sufficiently suppress occurrence of the creeping discharge.

In Patent Document 1, the ignition plug that suppresses occurrence of the creeping discharge is disclosed. Specifically, such an ignition plug is described in which a cylindrical ground side electrode and a high-volage side electrode are disposed, said high-voltage side electrode projecting toward the head of the ignition plug, then extending to the radially outer side so as to ensure a distance from the insulator, and thereafter turning back to extend toward the root of the ignition plug so as to be opposed to the ground side electrode.

However, the ignition plug with such unusual shapes is higher in cost than the conventional general-use ignition plug. According to the vehicle in which an internal combustion engine employing the ignition plug with such unusual shapes is mounted, since the widespread conventional ignition plug could not be used, the burden of the vehicle owner increases in terms of cost and maintenance.

### SUMMARY

This application discloses a technique for solving the problem as described above. An object of this application is to provide, with respect to a spark ignition-type internal combustion engine in which the pressure of the air-fuel mixture in the combustion chamber becomes high, an ignition device which can suppress occurrence of the creeping discharge even when the conventional ignition plug is used therein, and thus contributes to highly efficient operation of the internal combustion engine.

### Solution to Problem

An ignition device according to this application comprises: an ignition plug having a high-voltage side electrode and a ground side electrode; a high voltage generation device that applies a voltage to the high-voltage side electrode of the ignition plug; and an extension device that extends a dielectric breakdown-reaching time period that is a time period from when the voltage is applied to the high-voltage side electrode of the ignition plug, to when a voltage between the high-voltage side electrode and the ground side electrode of the ignition plug reaches a dielectric breakdown voltage.

### Advantageous Effects

By the ignition device according to this application, with respect to a spark ignition-type internal combustion engine in which the pressure of the air-fuel mixture in the combustion chamber becomes high, the time period subsequent to the application of the voltage to the electrode of the ignition plug until the inter-electrode voltage reaching the dielectric break-down voltage, is extended. This makes it possible to suppress occurrence of the creeping discharge even when the conventional ignition plug is used, and thus to contribute to highly efficient operation of the internal combustion engine.

### BRIEF DESCRIPTION OF DRAWINGS

FIG. 1 is a first configuration diagram of an ignition device according to Embodiment 1.

FIG. 2 is a first time chart showing voltages until the occurrence of dielectric breakdown across a gap of an ignition plug of the ignition device according to Embodiment 1.

FIG. 3 is a second configuration diagram of the ignition device according to Embodiment 1.

FIG. 4 is a hardware configuration diagram of a control device of the ignition device according to Embodiment 1.

FIG. 5 is a second time chart showing voltages until the occurrence of dielectric breakdown across the gap of the ignition plug of the ignition device according to Embodiment 1.

FIG. 6 is a configuration diagram of an ignition device according to Embodiment 2.

FIG. 7 is a time chart showing voltages until the occurrence of dielectric breakdown across a gap of an ignition plug of the ignition device according to Embodiment 2.

FIG. 8 is a configuration diagram of an ignition device according to Embodiment 3.

FIG. 9 is a time chart showing voltages until the occurrence of dielectric breakdown across a gap of an ignition plug of the ignition device according to Embodiment 3.

### DESCRIPTION OF EMBODIMENTS

Hereinafter, embodiments of an ignition device to be disclosed in this application will be described with reference to the accompanying drawings. Note that, in the drawings, the same reference numerals indicate the same or equivalent parts. The ignition device is an ignition device of a spark ignition-type internal combustion engine represented by a gasoline engine for automobiles.

### 1. Embodiment 1

### <Configuration of Ignition Device>

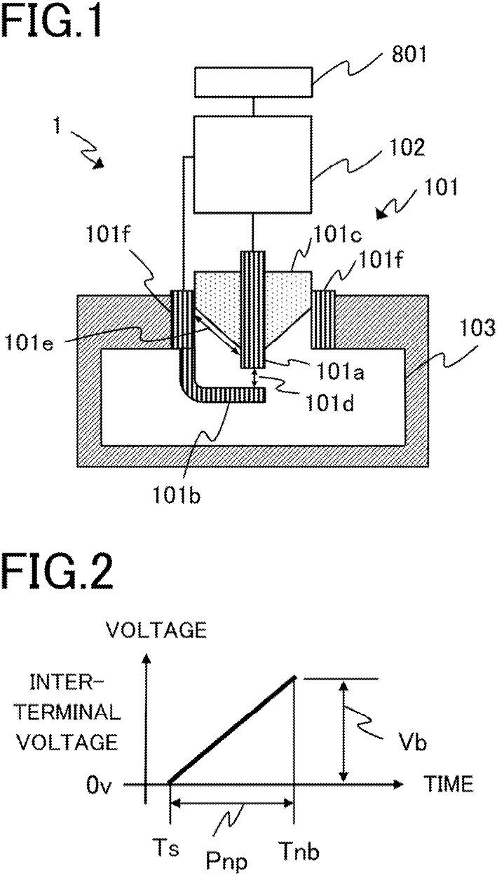

FIG. 1 is a first configuration diagram of an ignition device 1 according to Embodiment 1. In FIG. 1, the ignition device 1 is configured with an ignition plug 101, an ignition extension device 102 and a control device 801. In this Embodiment, the ignition plug 101 is attached to a combustion chamber 103 of a spark ignition-type automobile internal combustion engine.

The ignition plug 101 is the same as that usually used in a spark ignition-type automobile internal combustion engine. The ignition plug 101 includes a high-voltage side electrode 101a and a ground side electrode 101b, in which, in order to establish electrical insulation between the high-voltage side electrode 101a and the ground side electrode 101b, an insulator 101c is disposed between the high-voltage side electrode 101a and the ground side electrode 101b.

To the high-voltage side electrode 101a of the ignition plug 101, an ignition extension device 102 is connected. Using the potential of the ground side electrode 101b as a reference, the ignition extension device 102 generates and supplies a voltage for generating a spark discharge from the high-voltage side electrode 101a. Further, the ignition extension device 102 extends a time period from the start time of supplying the voltage to the high-voltage side electrode 101a until the generation of the spark discharge, whenever necessary.

In the operation of the spark ignition-type internal combustion engine, a spark discharge is established in the gap between the electrodes of the ignition plug 101. The gap between the electrodes with the presence of an air-fuel mixture is referred to as an air gap 101d. The air-fuel mixture is a mixture of a fuel and air. The ignition device 1 establishes a spark discharge in the air gap 101d to thereby ignite the air-fuel mixture in the combustion chamber 103. Since there are a small number of obstacles around the air gap 101d, the gap is almost in the midst of the air-fuel mixture. Thus, the spark discharge in the air gap 101d can transfer the discharge heat efficiently to the air-fuel mixture. Further, since the combustion flame after the ignition of the air-fuel mixture emerges in the air-fuel mixture, it is possible to transfer the heat of the combustion flame efficiently around the air-fuel mixture to thereby expand the flame through flame propagation. This makes it possible to achieve a proper combustion and thus to cause the internal combustion engine to operate efficiently.

### <Creeping Discharge>

In order to achieve reduction of the amount of carbon dioxide emitted from internal combustion engines as a countermeasure against global warming, downsizing of internal combustion engines to be mounted on vehicles is underway. With the progress of reduction in size and/or weight of the internal combustion engine itself by the use of supercharging, the traveling efficiency of the vehicle will be improved. Further, in order to efficiently take out energy due to thermal expansion, it is promoted to install a high compression-rate internal combustion engine. Namely, efforts to adapt internal combustion engines to supercharging and high compression rate are underway.

When the internal combustion engine is adapted to supercharging and high compression rate, the pressure of the air-fuel mixture in the combustion chamber 103 increases drastically. The phenomenon that the higher the pressure in a discharge space becomes, the less likely it is to generate a spark discharge in a gas, is a phenomenon that is well known according to the experiments by Friedrich Paschen, a physicist, and the like. When it becomes difficult to generate a spark discharge in the gas, a spark discharge will be generated along an interface between the gas and an insulating sold object or the like. This phenomenon is referred to as a creeping discharge.

In FIG. 1, a housing 101f of the ignition plug 101 is a casing made of metal and including screws, etc. for attaching the ignition plug 101 to the combustion chamber 103. Since the ground side electrode 101b made of metal is attached to the housing 101f by welding or the like, the ground side electrode 101b and the housing 101f are regarded as being at electrically the same potential. Accordingly, when the pressure in the combustion chamber 103 becomes high, a spark discharge is likely to be generated not in the air gap 101d but in a creepage gap 101e.

One side of the spark discharge in the creepage gap 101e is in contact with the insulator 101c. Thus, a large part of the discharge heat will be transferred to the insulator 101c, so that the air-fuel mixture cannot be heated efficiently.

Further, since the combustion flame after the ignition of the air-fuel mixture emerges in the vicinity of the insulator 101c, a large part of the heat of the combustion flame will be transferred to the insulator 101c. Thus, the proper propagation of the flame is impaired, so that a desired combustion cannot be achieved. Accordingly, it is not possible to cause the internal combustion engine to operate efficiently.

Furthermore, a spark discharge under a high pressure generates a very high temperature plasma, and this may melt a surface of the insulator 101c in contact with that plasma, to thereby cause failure such as abrasion, cracking or the like. There is a case where the insulator 101c is abraded into a groove-like shape when the creeping discharge is established repeatedly at a specific path on the surface of the insulator 101c. The abrasion of a groove-like shape is referred to as channeling. Such failure will shorten the life of the ignition plug 101.

According to these reasons, for spark ignition-type automobile internal combustion engines that are adapted to supercharging and high compression rate by which the air-fuel mixture in the combustion chamber reaches a high pressure, it is required to suppress the creeping discharge. As a method for suppressing occurrence of the creeping discharge, such a method is known in which an electric-field relaxation paint is applied to a portion where the creeping discharge may occur (for example, Japanese Utility Model Application Laid-open No. S60-51754). However, since the electric-field relaxation paint has limitations in performance, it is difficult to ensure its durability and reliability under high-temperature and high-pressure environment such as in the combustion chamber of the internal combustion engine.

For conventional ignition plugs in the spark ignition-type automobile internal combustion engines, a measure has also been taken to suppress the creeping discharge. The creeping discharge has been suppressed in such a manner that a sufficiently large creepage gap distance is ensured relative to the air gap distance. However, with the progress of downsizing, etc. of the internal combustion engines, the space for attaching the ignition plug becomes narrower, so that it become difficult to ensure the large creepage gap distance.

Further, according to the increase of the pressure in the combustion chamber, the temperature in the combustion chamber during the compression process is elevated to an extent much higher than before. In accordance with the elevation of the temperature in the combustion chamber, the heat accumulated in the insulator portion of the ignition plug increases. Accordingly, the fuel is likely to cause premature self-ignition because the insulator portion of the ignition plug serves as a heat source. The premature self-ignition is referred to as preignition. The preignition that is caused before the generation of the spark ignition between the electrodes of the ignition plug, may result in a problem such as failure of the engine, or the like.

For the above reasons, among the products of ignition plugs, those with a small diameter and a high heat-rating value become mainstream. Thus, it becomes difficult to ensure the sufficient creepage gap distance.

There are proposed special ignition plugs that suppress occurrence of the creeping discharge. For example, such an ignition plug is proposed in which a cylindrical ground side electrode and a high-volage side electrode are disposed, said high-voltage side electrode projecting toward the head of the ignition plug, then extending to the radially outer side so as to ensure a distance from the insulator, and thereafter turning back to extend toward the root of the ignition plug so as to be opposed to the ground side electrode (for example, Patent Document 1).

However, the ignition plug with such unusual shapes is higher in cost than the widespread general-use ignition plug, because of the complicated terminal shapes, etc. According to the vehicle in which an internal combustion engine employing the ignition plug with such unusual shapes is mounted, the widespread conventional ignition plug could not be used. Thus, according to such a vehicle, the burden of the vehicle owner increases in terms of cost and maintenance.

### <Suppression of Creeping Discharge>

The ignition device 1 shown in FIG. 1 can solve the foregoing problems and can suppress occurrence of the creeping discharge. It is possible to suppress occurrence of the creeping discharge by extending a time period from when the application of voltage between the high-voltage side electrode 101a and the ground side voltage 101b of the ignition plug 101 is started, to when the voltage between these electrode causes dielectric breakdown. Thus, even when the conventional ignition plug is used, it is possible to suppress occurrence of the creeping discharge.

In order to generate a spark discharge between the electrodes of the ignition plug that are electrically insulated to each other, it is required to change a gas as an insulating material existing between the electrodes, into an electrically conductive state. This change is called “dielectric breakdown”. Using the electric field induced by the application of the voltage between the electrodes, it is possible to accelerate the electric charges existing between the electrodes (in many cases, electrons) to thereby cause these charges to collide with molecules of the materials that constitutes the air-fuel mixture. Accordingly, an air-fuel mixture existing between the electrodes is ionized into positive ions and electrons.

By the electric field, electrons generated by the ionization are accelerated to further ionize, in the same manner, the other molecules existing between the electrodes one after another. A phenomenon in which the number of electrons increases in an exponential manner like this is referred to as electron avalanche. With the electron avalanche state, the electrical insulation property of the air gap is reduced, so that dielectric breakdown will occur.

It is important to extend the process time period from the start of voltage application between the electrodes of the ignition plug 101 until the occurrence of dielectric breakdown between the electrodes. It has been found experimentally that, when this time period is made relatively longer, the creeping discharge that is a spark discharge along the creepage surface of the insulator, becomes less likely to occur.

### <Normal Dielectric Breakdown-Reaching Time Period>

FIG. 2 is a first time chart showing voltages until the occurrence of dielectric breakdown across a gap of the ignition plug 101 of the ignition device 1 according to Embodiment 1. There is shown a waveform until when an inter-terminal voltage applied between the high-voltage side electrode 101a and the ground side electrode 101b reaches a dielectric breakdown voltage Vb at which dielectric breakdown occurs. A time period from a voltage application start time Ts for applying a voltage between the electrodes, to a normal dielectric breakdown time Tnb, is indicated as a normal dielectric breakdown-reaching time period Pnp. FIG. 2 shows a case where the time period until the occurrence of dielectric breakdown is not extended. The normal dielectric breakdown-reaching time period Pnp is, for example, about 10 microseconds.

In the time charts shown in FIG. 2 and other figures shown afterward, the abscissa represents time; however, it may represent a crank angle of an internal combustion engine. The ordinate represents an inter-terminal voltage applied across the gap. Shown here is a case where a positive voltage is applied to the high-voltage side electrode 101a.

The voltage to be applied to the high-voltage side electrode 101a may be a positive voltage or a negative voltage, relative to the ground side electrode 101b. However, in order to make it easier to achieve the effect of suppressing occurrence of the creeping discharge, that is created by extending the time period until the occurrence of dielectric breakdown, it is effective to apply a positive voltage to the high-voltage side electrode 101a. This has been ascertained experimentally.

In Embodiment 1, for simplifying the description, a voltage required for causing dielectric breakdown between the high-voltage side electrode 101a and the ground side electrode 101b is described as the dielectric breakdown voltage Vb, regardless of whether the discharge path is in the air gap 101d or the creepage gap 101e. Further, the air gap 101d and the creepage gap 101e are referred to collectively as gaps.

### <Configuration of Ignition Extension Device>

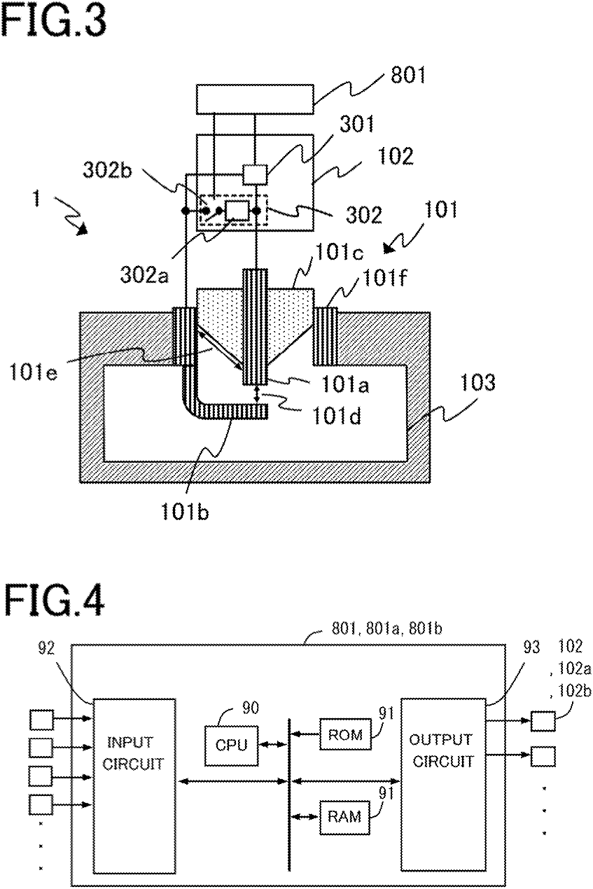

FIG. 3 is a second configuration diagram of the ignition device 1 according to Embodiment 1. This figure differs from FIG. 1 in that a specific configuration of the ignition extension device 102 is illustrated.

The ignition extension device 102 includes a high voltage generation device 301 and an extension device 302 that makes the time period until the occurrence of dielectric breakdown across the gap, relatively longer. In order to cause dielectric breakdown across the gap to thereby generate a spark discharge, the high voltage generation device 301 generates a high voltage with reference to the potential of the ground side electrode 101b and then supplies it to the high-voltage side electrode 101a of the ignition plug.

The extension device 302 is configured with: a capacitance element 302a connected electrically between the high-voltage side electrode 101a and the ground side electrode 101b; and a capacitance switching circuit 302b that switches between the electrical connection and disconnection of the capacitance element 302.

The capacitance switching circuit 302b is not essential. Namely, even if the capacitance element 302a is always put in the electrical connection state, it is possible to achieve an extending effect of the time period until the occurrence of dielectric breakdown. However, when the capacitance switching circuit 302b is not employed, the time period until the occurrence of dielectric breakdown is always extended. Accordingly, the spark discharge current at the time of dielectric breakdown always becomes larger, and thus there is a risk of reducing the life of the ignition plug 101.

Further, if the time period until the occurrence of dielectric breakdown in the ignition plug is designed to be always extended, the time period will be extended even when such extension is unnecessary, resulting in delay of the timing of ignition in the combustion chamber. In the cases where operation conditions such as an engine speed, etc., vary greatly as in the automobile internal combustion engine or the like, a problem arises if a difference becomes large between the timing at which a spark discharge is actually generated in the gap and the intended ignition timing. This is because there is a risk that this difference may reduce the power, response, etc. of the internal combustion engine.

When the capacitance switching circuit 302b is employed, the time period until the occurrence of dielectric breakdown can be extended only when necessary, to thereby overcome the above problem. In FIG. 3, the capacitance switching circuit 302b is controlled by the control device 801.

The capacitance element 302a is, for example, a capacitor of about 100 pF. The capacitance switching circuit 302b is, for example, a circuit in which plural high breakdown-voltage field-effect transistors are connected in series.

The high voltage generation device 301 may be configured, for example, with a primary coil that stores energy by energization, a secondary coil that is magnetically coupled to the primary coil, and a switching circuit that switches between a short-circuit state and an open state of the primary coil. When the switching circuit is turned on, power is supplied to the primary coil, so that energy is stored therein, and then, when the switching circuit is turned off, the power supply to the primary coil is interrupted, so that the stored energy is outputted from the secondary coil. In this case, the high voltage generation device 301 operates as a flyback ignition coil. In FIG. 3, turning on/off of the switching circuit is controlled by the control device 801.

### <Hardware Configuration of Control Device>

FIG. 4 is a hardware configuration diagram of the control device 801 of the ignition device according to Embodiment 1. Although the hardware configuration diagram of FIG. 4 may also be applied to control devices 801a, 801b to be described later, in the following, description will be made about the control device 801 as a representative. In this Embodiment, the control device 801 is a control device that controls the ignition extension device 102 of the ignition device 1 of the internal combustion engine. The respective functions of the control device 801 are implemented by a processing circuit included in the control device 801. Specifically, the control device 801 includes as the processing circuit: an arithmetic processing device 90 (computer) such as a CPU (Central Processing Unit) or the like; storage devices 91 for performing data transactions with the arithmetic processing device 90; an input circuit 92 for inputting external signals to the arithmetic processing device 90; an output circuit 93 for externally outputting signals from the arithmetic processing device 90; and the like.

As the arithmetic processing device 90, there may be included an ASIC (Application Specific Integrated Circuit), an IC (Integrated Circuit), a DSP (Digital Signal Processor), an FPGA (Field Programmable Gate Array), any one of a variety of logic circuits, any one of a variety of signal processing circuits, or the like.

Further, multiple arithmetic processing devices 90 of the same type or different types may be included so that the respective parts of processing are executed in a shared manner. As the storage devices 91, there are included a RAM (Random Access Memory) that is configured to allow reading and writing of data by the arithmetic processing device 90, a ROM (Read Only Memory) that is configured to allow reading of data by the arithmetic processing device 90, and the like. The input circuit 92 includes A-D converters, a communication circuit, etc. to which a variety of sensors and switches and a communication line are connected, and which serve to input the output signals of the sensors and switches, and communication information, to the arithmetic processing device 90. The output circuit 93 includes a driver circuit or the like for outputting control signals from the arithmetic processing device 90 to an external device including the ignition extension device 102.

The respective functions that the control device 801 includes, are implemented in such a manner that the arithmetic processing device 90 executes software (programs) stored in the storage device 91 such as the ROM or the like, to thereby cooperate with the other hardware in the control device 801, such as the other storage device 91, the input circuit 92, the output circuit 93, etc. Note that the set data of threshold values, determinative values, etc. to be used by the control device 801 is stored, as a part of the software (programs), in the storage device 91 such as the ROM or the like. Although each of the functions that the control device 801 has, may be established by a software module, it may be established by a combination of software and hardware.

### <Extended Dielectric Breakdown-Reaching Time Period>

FIG. 5 is a second time chart showing voltages until the occurrence of dielectric breakdown in the gap of the ignition plug 101 of the ignition device 1 according to Embodiment 1. FIG. 5 illustrates an operation of how the time period until the occurrence of dielectric breakdown is extended.

At the voltage application start time Ts at which the high voltage generation device 301 is going to start supplying the voltage to the high-voltage side electrode 101a, the capacitance switching circuit 302b has an open (OFF) state. The capacitance element 302a has, as an electric circuit, a state separated off from the high-voltage side electrode 101a.

After the voltage application start time Ts, the voltage at the high-voltage side electrode 101a begins to rise. In the state in which the capacitance element 302a is electrically separated off, when the voltage supply is continued from the high voltage generation device 301 to the high-voltage side electrode 101a, the inter-terminal voltage will vary as indicated by the broken line. This voltage will reach the dielectric breakdown voltage Vb at the normal dielectric breakdown time Tnb, resulting in dielectric breakdown across the gap. On this occasion, if the combustion chamber 103 is in a state in which its pressure is high, the dielectric breakdown and the spark discharge are more likely to occur in the creepage gap 101e than in the other gap.

At a capacitance connection time Tc before the occurrence of dielectric breakdown between the terminals, the capacitance switching circuit 302b is switched to a connection state (turned on). The capacitance element 302a is electrically connected to the high-voltage side electrode 101a. The rising rate of the inter-terminal voltage is then decreased as indicated by the solid line in FIG. 5, and thus the voltage rise becomes slow. The time at which the voltage reaches the dielectric breakdown voltage Vb required for causing dielectric breakdown in the gap, is a delayed dielectric breakdown time Tcb.

Namely, the time period from the voltage application start time Ts at which the voltage application is started, to the delayed dielectric breakdown time Tcb at which dielectric breakdown occurs in the gap, is given as an extended dielectric breakdown-reaching time period Pcp. Thus, it is possible to make the time period until the occurrence of dielectric breakdown longer relative to the normal dielectric breakdown-reaching time period Pnp. This makes it possible to generate a spark discharge in the air gap 101d. The extended dielectric breakdown-reaching time period Pcp is, for example, about 100 microseconds.

Since the time period from the start of the voltage application to the high-voltage side electrode 101a of the ignition plug 101 until the occurrence of dielectric breakdown, is extended, the ignition timing is delayed. The control device 801 may estimate the delay time beforehand to thereby correct the voltage application start time Ts so that it becomes earlier.

In FIG. 5, a case is shown where the capacitance connection time Tc is set at a timing after the voltage application start time Ts. However, it is not essential that the capacitance connection time Tc be set at a timing after the voltage application start time Ts. Even when the capacitance connection time Tc is set at a timing before the voltage application start time Ts, it is possible to achieve an extending effect of the time period until the occurrence of dielectric breakdown.

### <Selection of Whether Extension of Dielectric Breakdown-Reaching Time Period is Necessary or not>

When the pressure of the air-fuel mixture in the combustion chamber becomes higher, the creeping discharge becomes more likely to occur. Accordingly, the time period until the occurrence of dielectric breakdown may be extended when the load of the internal combustion engine, that is represented by a throttle position of the internal combustion engine, an intake air quantity per one rotation of the crankshaft, a pressure in the intake pipe, a fuel supply amount per one rotation of the crankshaft, an output torque of the internal combustion engine, and the like, exceeds a predetermined load. This is because when the load of the internal combustion engine increases, the pressure of the air-fuel mixture in the combustion chamber becomes higher.

The pressure of the air-fuel mixture in the combustion chamber may be detected directly by an in-cylinder pressure sensor. The time period until the occurrence of dielectric breakdown may be extended when the in-cylinder pressure before the start of combustion exceeds a predetermined in-cylinder pressure (for example, 1500 kilopascals). Whether or not the in-cylinder pressure exceeds the predetermined pressure may be determined by estimating the in-cylinder pressure from the intake air quantity, the engine speed or the like, without using the in-cylinder pressure sensor. Furthermore, the extended amount of the time period until the occurrence of dielectric breakdown may be increased as the load of the internal combustion engine or the in-cylinder pressure becomes higher.

In the case where the ignition device 1 is used in an engine in which its operation conditions vary, such as a spark ignition-type automobile internal combustion engine or the like, the working condition of the extension device 302 may be determined on the basis of a table or map of working conditions predetermined for the respective operation conditions. Further, the capacitance connection time Tc at which the capacitance switching circuit 302b is switched to the connection state may be determined for each of the operation conditions. Furthermore, the dielectric breakdown-reaching time period may be changed on the basis of a table or map of reference dielectric breakdown-reaching time periods predetermined for the respective operation conditions. Any of these makes it possible to suppress occurrence of the creeping discharge on an as-needed basis, without impairing the life of the ignition plug.

As described above, when the time period until the occurrence of dielectric breakdown is made longer relative to the normal dielectric breakdown-reaching time period, it is possible to increase the possibility of occurrence of the dielectric breakdown and the spark discharge in the air gap 101d. Accordingly, in the case where the pressure of the air-fuel mixture in the combustion chamber becomes high, it is possible to suppress occurrence of the creeping discharge even when a conventional ignition plug is used, to thereby cause the internal combustion engine to operate efficiently.

In FIG. 3, the ignition device 1 is configured so that the control device 801 controls the ignition extension device 102. However, the control device 801 is not an essential constituent. The ignition device 1 may be configured using mechanical and electrical components, such as, an ignitor that generates a high voltage in response to the rotation of the crankshaft of an internal combustion engine, a distributor that distributes the high voltage to the ignition plugs of the respective cylinders, a centrifugal governor that controls ignition timings, a boost switch that works by an intake-pipe negative pressure, and the like. Even in this case, it is possible, when the load of the internal combustion engine is high, to extend the dielectric breakdown-reaching time period to thereby change it to the extended dielectric breakdown-reaching time period Pcp.

### 2. Embodiment 2

### <Configuration of Ignition Extension Device>

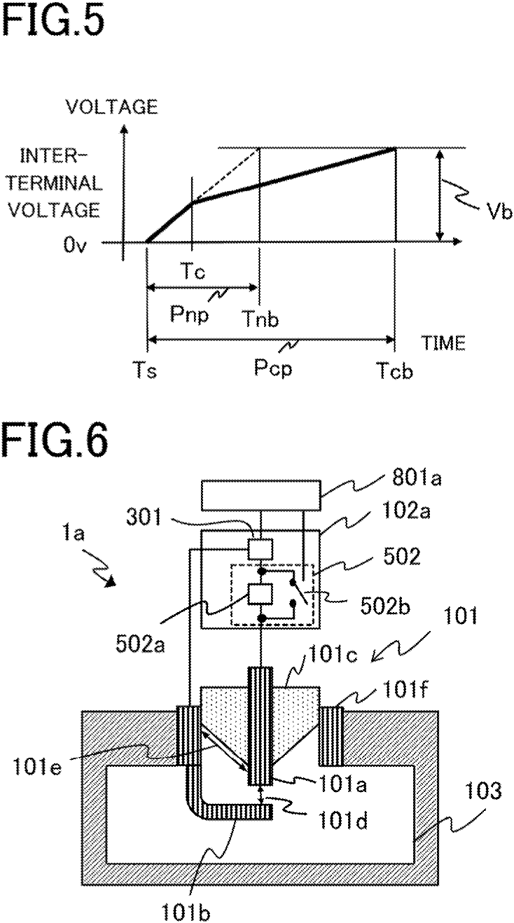

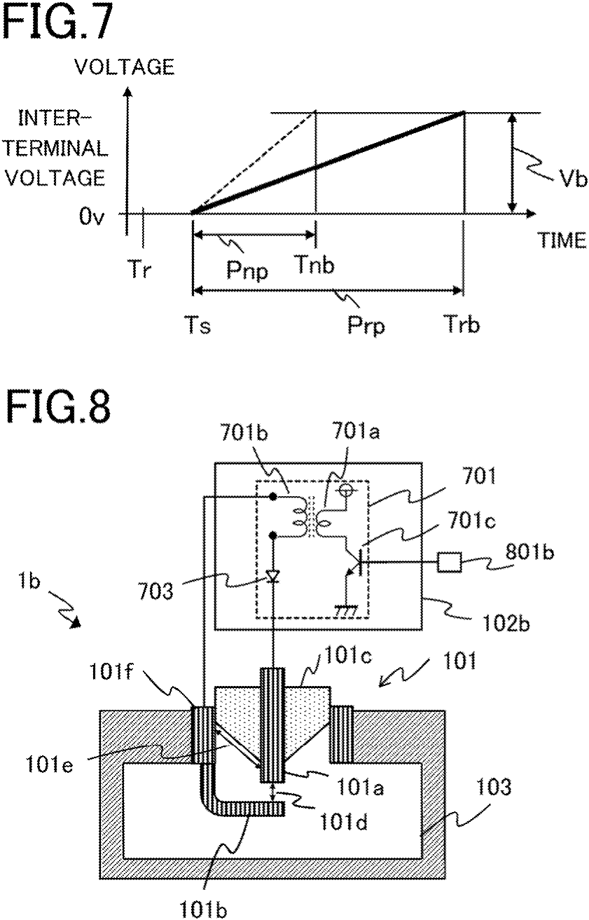

FIG. 6 is a configuration diagram of an ignition device 1a according to Embodiment 2. FIG. 7 is a time chart showing voltages until the occurrence of dielectric breakdown between the terminals of the ignition plug 101 of the ignition device 1a according to Embodiment 2. In Embodiment 1, the extension device 302 is configured as a device having the capacitance element 302a. In comparison to this, an extension device 502 in Embodiment 2 differs in that it is configured as a device having a resistance element 502a.

The ignition device 1a is configured with an ignition plug 101, an ignition extension device 102a and a control device 801a. The ignition extension device 102a includes the high voltage generation device 301 and the extension device 502. FIG. 4 can be employed for the hardware configuration of the control device 801a.

In order to cause dielectric breakdown in the gap to generate a spark discharge, the high voltage generation device 301 generates a high voltage with reference to the potential of the ground side electrode 101b. Then, the high voltage generation device 301 supplies the high voltage to the high-voltage side electrode 101a of the ignition plug 101.

The extension device 502 extends the time period until the occurrence of dielectric breakdown across the gap. The extension device 502 has the resistance element 502a connected between the high voltage generation device 301 and the high-voltage side electrode 101a. Further, it is configured with a resistance switching circuit 502b that switches between electrically enabled and disabled states of the resistance element 502a.

The resistance switching circuit 502b can disable the resistance element 502a by causing short-circuiting between the high-voltage side electrode 101a of the ignition plug and the high voltage generation device 301. The resistance element 502a is electrically disabled when both ends thereof are interconnected and thus short-circuited by the resistance switching circuit 502b (turned on). The resistance element 502a is electrically enabled when the resistance switching circuit 502b is made open (turned off).

The resistance switching circuit 502b is not an essential configuration element. Even in the case where the resistance switching circuit 502b is always put in the open state or the resistance switching circuit 502b is absent, it is possible to achieve an extending effect of the time period until the occurrence of dielectric breakdown.

In that case, the resistance element 502a is always put in an electrically enabled state. Accordingly, the current to be supplied to the high-voltage side electrode 101a becomes always smaller, and thus the time period until the occurrence of dielectric breakdown is always extended.

If the time period until the occurrence of dielectric breakdown in the ignition plug is designed to be always extended, the time period will be extended even when such extension is unnecessary, resulting in delay of the timing of ignition in the combustion chamber. In the cases where operation conditions such as an engine speed, etc., vary greatly as in the automobile internal combustion engine or the like, a problem arises if a difference becomes large between the timing at which a spark discharge is actually generated in the gap and the intended ignition timing. This is because there is a risk that this difference may reduce the power, response, etc. of the internal combustion engine.

When the resistance switching circuit 502b is employed, the time period until the occurrence of dielectric breakdown can be extended only when necessary, to thereby overcome the above problem. In FIG. 6, the resistance switching circuit 502b is controlled by the control device 801a.

The resistance element 502a is, for example, a resistor of about 100 kΩ. The resistance switching circuit 502b is, for example, a circuit in which plural high breakdown-voltage IGBTs (Insulated Gate Bipolar Transistors) are connected in series.

### <Extended Dielectric Breakdown-Reaching Time Period>

When the extension device 502 shown in FIG. 6 is operated, the voltage waveform at the high-voltage side electrode 101a is given as FIG. 7. At the voltage application start time Ts, the high voltage generation device 301 starts supplying the voltage to the high-voltage side electrode 101a. At the voltage application start time Ts, the resistance switching circuit 502b is in the open state and thus the resistance element 502a is electrically enabled.

After the voltage application start time Ts, the voltage at the high-voltage side electrode 101a begins to rise. On this occasion, if the resistance switching circuit 502b is in the connection state, the resistance element 502a is put in the electrically disabled state. In that case, a large current is supplied from the high voltage generation device 301, so that the voltage at the high-voltage side electrode 101a rises steeply as indicated by the broken line in the figure. The voltage will reach the dielectric breakdown voltage Vb at the normal dielectric breakdown time Tnb, resulting in dielectric breakdown in the gap.

On this occasion, if the combustion chamber 103 is in a state in which its pressure is high, the dielectric breakdown and the spark discharge are more likely to occur in the creepage gap 101e than in the other gap.

At a resistance connection time Tr before the voltage application start time Ts, the resistance switching circuit 502b is switched to the open state to thereby put the resistance element 502a in the electrically enabled state. The rising rate of the inter-terminal voltage is decreased as indicated by the solid line in FIG. 7, and thus the voltage rise becomes slow. The time at which the voltage reaches the dielectric breakdown voltage Vb required for causing dielectric breakdown in the gap, is a delayed dielectric breakdown time Trb.

The time period from the voltage application start time Ts at which the voltage application is started, to the delayed dielectric breakdown time Trb at which dielectric breakdown occurs in the gap, is given as an extended dielectric breakdown-reaching time period Prp. Thus, it is possible to make the time period until the occurrence of dielectric breakdown longer relative to the normal dielectric breakdown-reaching time period Pnp. This makes it possible to generate a spark discharge in the air gap 101d. The extended dielectric breakdown-reaching time period Prp is, for example, about 100 microseconds.

In FIG. 6, a case is shown where the resistance connection time Tr at which the resistance switching circuit 502b is switched to the open state, is set at a timing before the voltage application start time Ts. However, it is not essential that the resistance connection time Tr be set at a timing before the voltage application start time Ts. The resistance connection time Tr may be set at a timing after the voltage application start time Ts.

In that case, like in the time chart of FIG. 5 according to Embodiment 1, the rising rate of the inter-terminal voltage is decreased from an intermediate time.

After the voltage application start time Ts, the voltage is applied to the high-voltage side electrode 101a under the condition that the resistance switching circuit 502a is put in the connection state and thus the resistance element 502a is put in the disabled state. At a timing before the normal dielectric breakdown time Tnb, the resistance connection time Tr is set, so that the resistance switching circuit 502a is put in the open state and thus the resistance element 502a is put in the enabled state. Accordingly, after the resistance connection time Tr, the rising rate of the inter-terminal voltage is decreased and thus the voltage rise becomes slow. Even if this is the case, it is possible to achieve an extending effect of the time period until the occurrence of dielectric breakdown.

### <Selection of Whether Extension of Dielectric Breakdown-Reaching Time Period is Necessary or not>

The time period until the occurrence of dielectric breakdown may be extended when the load of the internal combustion engine, that is represented by a throttle position of the internal combustion engine, an intake air quantity per one rotation of the crankshaft, a pressure in the intake pipe, a fuel supply amount per one rotation of the crankshaft, an output torque of the internal combustion engine, and the like, exceeds a predetermined load. Further, the time period until the occurrence of dielectric breakdown may be extended when an in-cylinder pressure before the start of combustion exceeds a predetermined in-cylinder pressure (for example, about 1500 kilopascals). Furthermore, the extended amount of the time period until the occurrence of dielectric breakdown may be increased as the load of the internal combustion engine or the in-cylinder pressure becomes higher.

In the case where the ignition device 1a is used in an engine in which its operation conditions vary, such as a spark ignition-type automobile internal combustion engine or the like, the working condition of the extension device 502 may be determined on the basis of a table or map of working conditions predetermined for the respective operation conditions. Further, the resistance connection time Tr at which the resistance switching circuit 502b is switched to the open state may be determined for each of the operation conditions. Furthermore, the dielectric breakdown-reaching time period may be changed on the basis of a table or map of reference dielectric breakdown-reaching time periods predetermined for the respective operation conditions. Any of these makes it possible to suppress occurrence of the creeping discharge on an as-needed basis, without impairing the life of the ignition plug.

In this manner, it is possible to increase the possibility of occurrence of the dielectric breakdown and the spark discharge in the air gap 101d. Accordingly, in the case where the pressure of the air-fuel mixture in the combustion chamber becomes high, it is possible to suppress occurrence of the creeping discharge even when a conventional ignition plug is used, to thereby cause the internal combustion engine to operate efficiently.

In FIG. 6, the ignition device 1a is configured so that the control device 801a controls the ignition extension device 102a. However, the control device 801a is not an essential constituent. The ignition device 1a may be configured using mechanical and electrical components, such as, the ignitor, the distributor, the centrifugal governor, the boost switch, and the like. Even in this case, it is possible, when the load of the internal combustion engine is high, to extend the dielectric breakdown-reaching time period to thereby change it to the extended dielectric breakdown-reaching time period Prp.

### 3. Embodiment 3

### <Configuration of Ignition Extension Device>

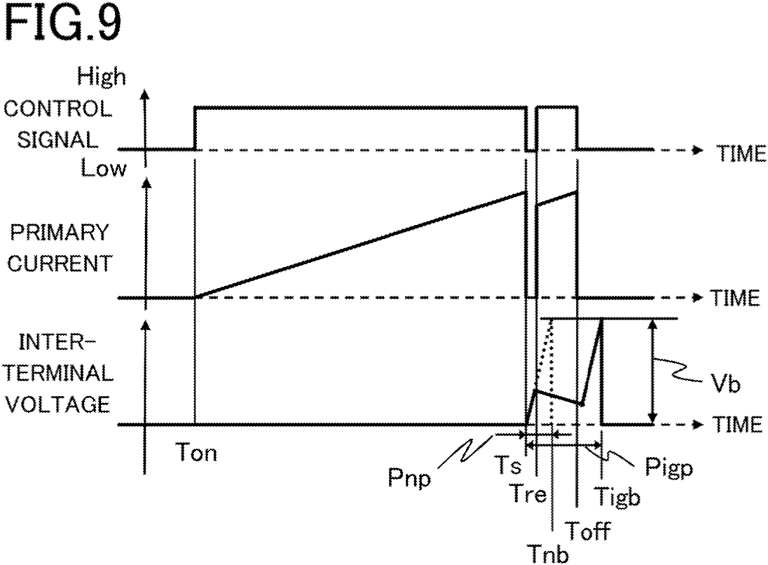

FIG. 8 is a configuration diagram of an ignition device 1b according to Embodiment 3. FIG. 9 is a time chart showing voltages until the occurrence of dielectric breakdown between the terminals of the ignition plug 101 of the ignition device 1b according to Embodiment 3.

In FIG. 8, the ignition device 1b includes an ignition extension device 102b that is integrated with a high voltage generation device 701. Further, it includes a control device 801b that supplies a control signal for making the time period until the occurrence of dielectric breakdown between the terminals of the ignition plug 101, relatively longer. FIG. 4 can be employed for the hardware configuration of the control device 801a.

The high voltage generation device 701 is configured with a primary coil 701a that stores energy by energization, a secondary coil 701b that is magnetically coupled to the primary coil 701a, and a switching circuit 701c that switches between current supply from a power source to the primary coil 701a and interruption thereof.

The high voltage generation device 701 stores energy by supplying power to the primary coil 701a, and then outputs the stored energy from the secondary coil 701b by interrupting the power supply to the primary coil 701a. The high voltage generation device 701 constitutes a flyback ignition coil. In order to generate an ignition spark, the control device 801b turns on and off the switching circuit 701c. The control device 801b further controls the switching circuit 701c so that the time period until the occurrence of dielectric breakdown in the gap of the ignition plug 101 becomes relatively longer.

### <Extended Dielectric Breakdown-Reaching Time Period>

In FIG. 9, a control signal for the switching circuit 701c, a primary current flowing in the primary coil 701a and an inter-terminal voltage applied to the high-voltage side electrode 101a, are shown. At a primary-coil energization start time Ton, the control device 801b switches the control signal to a high-level side to thereby turn on the switching circuit 701c. The primary current begins to rise, so that energy is stored in the primary coil 701a.

The high voltage generation device 701 includes a diode 703 in a line through which the secondary coil 701b is connected to the high-voltage side electrode 101a. The diode 703 is provided in order that no voltage is applied to the high-voltage side electrode 101a at the primary-coil energization start time Ton at which the primary current begins to flow. The diode 703 may be located between the secondary coil 701b and the ground side electrode 101b.

At the voltage application start time Ts, the control signal is switched to a low-level side, so that the switching circuit 701c is turned off. On this occasion, the primary current is shut off, so that a voltage is induced in the secondary coil 701b magnetically coupled to the primary coil 701a. Accordingly, the inter-terminal voltage applied to the high-voltage side electrode 101a connected to the secondary coil 701b begins to rise.

If this state is maintained, namely, if the control signal is kept in the low-level side after the voltage application start time Ts, the inter-terminal voltage continues to rise as indicated by the broken line in FIG. 9, and reaches the dielectric breakdown voltage Vb at the normal dielectric breakdown time Tnb. On this occasion, if the combustion chamber 103 is in a state in which its pressure is high, the dielectric breakdown and the spark discharge are more likely to occur in the creepage gap 101e than in the other gap.

At a primary-coil energization restart time Tre before that the inter-terminal voltage reaches the dielectric breakdown voltage Vb, the control signal is switched to the high-level side, so that the switching circuit 701c is turned on again. On this occasion, the primary current begins to flow again in the primary coil 701a and the voltage output from the secondary coil 701b is stopped. Since the high-voltage side electrode 101a has a stray capacitance, when the voltage supply from the secondary coil 701b is stopped, the inter-terminal voltage does not immediately reach zero and begins to fall moderately.

At a primary-coil energization second interruption time Toff before the inter-terminal voltage reaching zero, the control signal is switched to the low-level side again, so that the switching circuit 701a is turned off again. On this occasion, the primary current is shut off again, so that a voltage begins to be outputted again from the secondary coil 701b. The inter-terminal electrode begins to rise again and then reaches the dielectric breakdown voltage Vb at a delayed dielectric breakdown time Tigb, to thereby generate a spark discharge in the gap.

Namely, the time period from the voltage application start time Ts at which the inter-terminal voltage begins to rise, to the delayed dielectric breakdown time Tigb at which dielectric breakdown occurs in the gap, is given as an extended dielectric breakdown-reaching time period Pigp. Thus, it is possible to make the time period until the occurrence of dielectric breakdown longer relative to the normal dielectric breakdown-reaching time period Pnp. This makes it possible to generate a spark discharge in the air gap 101d. The extended dielectric breakdown-reaching time period Pigp is, for example, about 100 microseconds.

In FIG. 9, the control signal is switched to the low-level side at the voltage application start time Ts, and thereafter, the control signal is switched to the high-level side at the primary-coil energization restart time Tre. Then, the control signal is switched to the low-level side again at the primary-coil energization second interruption time Toff. However, switching of the control signal to the high-level side or the low-level side may be performed multiple times. Switching of the control signal to the high-level side or the low-level side may be repeated so that an intended dielectric breakdown-reaching time period is achieved.

### <Selection of Whether Extension of Dielectric Breakdown-Reaching Time Period is Necessary or not>

The time period until the occurrence of dielectric breakdown may be extended when the load of the internal combustion engine, that is represented by a throttle position of the internal combustion engine, an intake air quantity per one rotation of the crankshaft, a pressure in the intake pipe, a fuel supply amount per one rotation of the crankshaft, an output torque of the internal combustion engine, and the like, exceeds a predetermined load. Further, the time period until the occurrence of dielectric breakdown may be extended when an in-cylinder pressure before the start of combustion exceeds a predetermined in-cylinder pressure (for example, about 1500 kilopascals). Furthermore, the extended amount of the time period until the occurrence of dielectric breakdown may be increased as the load of the internal combustion engine or the in-cylinder pressure becomes higher.

In the case where the ignition device 1b is used in an engine in which its operation conditions vary, such as a spark ignition-type automobile internal combustion engine or the like, the working condition of the control device 801b for extension control may be determined on the basis of a table or map of working conditions predetermined for the respective operation conditions. Further, the voltage application start time Ts, the primary-coil energization restart time Tre and the primary-coil energization second interruption time Toff may be determined for each of the operation conditions. Furthermore, the dielectric breakdown-reaching time period may be changed on the basis of a table or map of reference dielectric breakdown-reaching time periods predetermined for the respective operation conditions. Any of these makes it possible to suppress occurrence of the creeping discharge on an as-needed basis, without impairing the life of the ignition plug.

In this manner, it is possible to increase the possibility of occurrence of the dielectric breakdown and the spark discharge in the air gap 101d. Accordingly, in the case where the pressure of the air-fuel mixture in the combustion chamber becomes high, it is possible to suppress occurrence of the creeping discharge even when a conventional ignition plug is used, to thereby cause the internal combustion engine to operate efficiently. Thus, the amount of the greenhouse gas emitted from internal combustion engines is reduced, and this can be useful for environmental safeguard.

In this application, a variety of exemplary embodiments and examples are described; however, every characteristic, configuration or function that is described in one or more embodiments, is not limited to being applied to a specific embodiment, and may be applied singularly or in any of various combinations thereof to another embodiment. Accordingly, an infinite number of modified examples that are not exemplified here are supposed within the technical scope disclosed in the present description. For example, such cases shall be included where at least one configuration element is modified; where at least one configuration element is added or omitted; and furthermore, where at least one configuration element is extracted and combined with a configuration element of another embodiment.

What is claimed is:

1. An ignition device, comprising:
an ignition plug having a high-voltage side electrode and a ground side electrode;
a high voltage generation device that applies a voltage to the high-voltage side electrode of the ignition plug; and
an extension device that extends a dielectric breakdown-reaching time period that is a time period from when the voltage is applied to the high-voltage side electrode of the ignition plug, to when a voltage between the high-voltage side electrode and the ground side electrode of the ignition plug reaches a dielectric breakdown voltage.

2. The ignition device of claim 1, wherein the extension device extends the dielectric breakdown-reaching time period by using a capacitance element connected between the high-voltage side electrode and the ground side electrode of the ignition plug.

3. The ignition device of claim 2, wherein the extension device has a capacitance switching circuit that establishes an electrical connection or dis-connection between the high-voltage side electrode of the ignition plug and the capacitance element.

4. The ignition device of claim 1, wherein the extension device extends the dielectric breakdown-reaching time period by using a resistance element connected between the high-voltage side electrode of the ignition plug and the high voltage generation device.

5. The ignition device of claim 4, wherein the extension device has a resistance switching circuit that performs electrical switching on whether the high-voltage side electrode of the ignition plug and the high voltage generation device are shortcircuited to each other, or connected to each other through the resistance element inserted in series therebetween.

6. The ignition device of claim 1, wherein the high voltage generation device has: a primary coil; a secondary coil that is magnetically coupled to the primary coil and that supplies a secondary current to the ignition plug; and a switching circuit that switches between power supply from a power source to the primary coil and interruption thereof; and generates the voltage by discharging from the secondary coil, energy stored in the primary coil due to the power supply thereto, by interrupting the power supply to the primary coil; and
wherein the extension device extends the dielectric breakdown-reaching time period by turning on and off the switching circuit.

7. The ignition device of claim 1, wherein the extension device extends the dielectric breakdown-reaching time period when, with respect to an internal combustion engine provided with the ignition device, a pressure of an air-fuel mixture in its combustion chamber is higher than a predetermined pressure.

8. The ignition device of claim 1, wherein the extension device extends the dielectric breakdown-reaching time period when, with respect to an internal combustion engine provided with the ignition device, its load is larger than a predetermined load.

9. The ignition device of claim 1, wherein the extension device changes the dielectric breakdown-reaching time period depending on operation conditions of an internal combustion engine provided with the ignition device.

10. The ignition device of claim 9, wherein the extension device has a table of reference dielectric breakdown-reaching time periods that are predetermined depending on the operation conditions of the internal combustion engine provided with the ignition device, and changes the dielectric breakdown-reaching time period on a basis of that table.

11. The ignition device of claim 1, wherein the voltage that the high voltage generation device applies to the high-voltage side electrode of the ignition plug, is a positive voltage.
